(19) United States
(12) Patent Application Publication
(10) Pub. No.: US 2015/0009836 A1
(43) Pub. Date: Jan. 8, 2015

(54) Side Information for Channel State Information Reporting in Wireless Systems

(71) Applicant: BROADCOM CORPORATION, IRVINE, CA (US)

(72) Inventors: Djordje Tujkovic, Mountain View, CA (US); Gowrisankar Somichetty, Bangalore (IN); Mrinmoy Jana, Bangalore (IN); Sriram Rajagopal, Bangalore (IN)

(73) Assignee: BROADCOM CORPORATION, IRVINE, CA (US)

(21) Appl. No.: 13/956,205

(22) Filed: Jul. 31, 2013

Related U.S. Application Data
(60) Provisional application No. 61/843,085, filed on Jul. 5, 2013.

(51) Int. Cl. H04L 12/26

(52) U.S. Cl. CPC H04L 43/062
USPC 370/252

(57) ABSTRACT

In MIMO systems employing closed loop link adaptation, channel state information reporting can be enhanced using various types of side information, such as scheduling information indicating constraints on the scheduler related to the generation of downlink MIMO signals.

### CROSS REFERENCE TO RELATED APPLICATIONS

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:

U.S. Provisional Application Ser. No. 61/843,085, entitled “Side Information for Channel State Information Reporting in Wireless Systems,” filed Jul. 5, 2013, pending.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

1. Technical Field

The present disclosure relates generally to wireless communication systems, and more particularly, to channel state information reporting in wireless communication systems.

2. Description of Related Art

Multiple-Input Multiple-Output (MIMO) technology is available in many 4G wireless communication systems, such as Long Term Evolution-Advanced (LTE-A), WirelessMAN-Advanced and IEEE 802.16m systems. Within a MIMO system, more than one transmit antenna is used to communicate with more than one receive antenna. Since signals from different transmit antennas take different paths to reach the receive antennas and the signals may arrive at different times, in order to achieve the desired throughput, accurate measurements of the multipath conditions are needed to optimize link adaptation.

Broadly, two types of link adaptation are generally supported in MIMO 4G systems: open loop and closed loop. In both open loop and closed loop link adaptation, channel state information (CSI) is reported from the receiver (i.e., user equipment) to the transmitter (i.e., base station or eNodeB) to enable the transmitter to optimize the transmission mode. For example, based on the CSI, the transmitter may select a particular transmit antenna configuration and/or a particular data modulation and coding scheme (MCS) level. Open loop and closed loop link adaptation differ in the level of detail with which the CSI is reported to the transmitter, with more detail being included in closed loop link adaptation.

For example, in 4G Long Term Evolution (LTE) networks employing MIMO closed loop link adaptation, the CSI report includes a precoding matrix index (PMI), channel quality information (CQI) and a rank indicator (RI). The RI provides an indication of the number of layers (spatially multiplexed data streams) that can be supported on the downlink MEMO channel, the CQI provides an overall measurement of the channel conditions of the MIMO channel, and the PMI is used by the transmitter to determine an optimum precoding matrix for the current channel conditions.

To generate the CSI feedback information, the receiver typically generates a capacity metric over all combinations of transmission schemes and then determines the channel state information that optimizes the metric for a target packet error rate. However, the capacity metric assumes that the modulation and coding scheme (MCS) levels are continuous and that the transmitter can employ any MCS level that the receiver supports. In reality, the possible MCS levels are typically discrete and finite. For example, in some situations, the scheduler in the transmitter may utilize a fixed MCS level. In this situation, using the capacity metric may not produce the optimal PMI.

### BRIEF DESCRIPTION OF THE SEVERAL VIEWS OF THE DRAWINGS

FIG. 1 illustrates an example of a portion of a communication system that supports both wired and wireless client devices in accordance with one or more embodiments of the present disclosure;

FIG. 2 illustrates an example of a portion of a wireless communication system facilitating a Multiple-Input Multiple-Output (MIMO) transmission between a wireless network device and a wireless client device in accordance with one or more embodiments of the present disclosure;

FIG. 3 illustrates an example of an embodiment of a MIMO wireless client device in accordance with the present disclosure;

FIG. 4 illustrates an example of an embodiment of a MIMO wireless network device in accordance with the present disclosure;

FIG. 5 illustrates an example of an operation of a processing module within a MIMO wireless client device in accordance with the present disclosure;

FIG. 6 illustrates an example of a method for determining channel state information within a MIMO wireless client device in accordance with the present disclosure;

FIG. 7 illustrates an example of an operation of a channel state information (CSI) parameter selection module within a MIMO wireless client device for determining a precoding matrix index in accordance with the present disclosure;

FIG. 8 illustrates an example of a method for determining a precoding matrix index within a MIMO wireless client device in accordance with the present disclosure;

FIG. 9 illustrates an example of an operation of a CSI parameter selection parameter module within a MIMO wireless client device for determining a rank indicator in accordance with the present disclosure; and

FIG. 10 illustrates an example of a method for determining a rank indicator within a MIMO wireless client device in accordance with the present disclosure.

### DETAILED DESCRIPTION

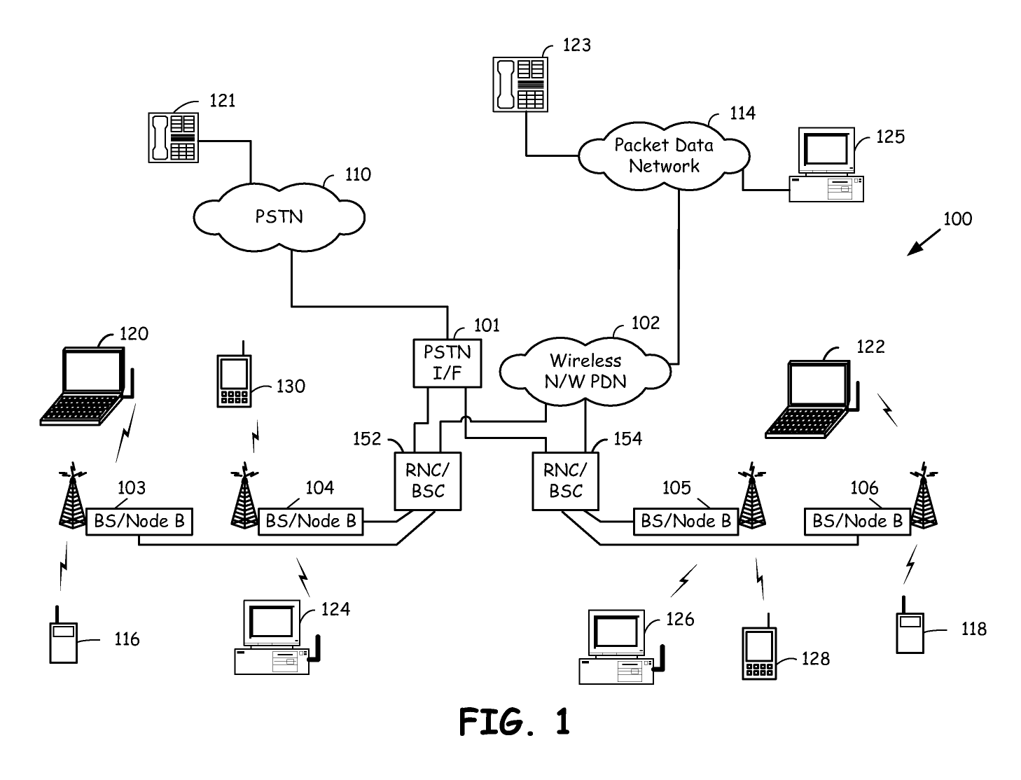

FIG. 1 illustrates an example of a portion of a communication system that supports both wired and wireless client devices in accordance with embodiments of the present disclosure. The communication system 100 includes a Public Switched Telephone Network (PSTN) Interface 101, e.g., Mobile Switching Center, a wireless network packet data network 102 that includes GPRS Support Nodes, EDGE Support Nodes, WCDMA Support Nodes, and other components, Radio Network Controllers/Base Station Controllers (RNC/BSCs) 152 and 154, and Base Stations/Node Bs/eNodeBs (hereinafter referred to as wireless network devices) 103, 104, 105, and 106. The wireless network packet data network 102 couples to additional private and public packet data networks 114, e.g., the Internet, WANs, LANs, etc. A conventional voice terminal 121 couples to the PSTN 110. A Voice over Internet Protocol (VoIP) terminal 123 and a personal computer 125 couple to the Internet/WAN 114. The PSTN Interface 101 couples to the PSTN 110. Of course, this particular structure may vary from system to system.

Each of the wireless network devices 103-106 services a cell/set of sectors and supports wireless communications therein. Wireless links that include both forward (down) link components and reverse (up) link components support wireless communications between the wireless network devices and their serviced wireless client devices 116, 118, 120, 122, 124, 126, 128, and 130. These wireless links support digital data communications, VoIP communications, and other digital multimedia communications. The communication system 100 may also be backward compatible in supporting analog operations as well. The communication system 100 supports, for example, one or more of the following: the Long Term Evolution (LTE) standard, LTE-Advanced (LTE-A) standard, Mobile WiMAX standard, WirelessMAN-Advanced standard, IEEE 802.16m standard, UMTS/WCDMA standards, the Global System for Mobile telecommunications (GSM) standards, the GSM General Packet Radio Service (GPRS) extension to GSM, the Enhanced Data rates for GSM (or Global) Evolution (EDGE) standards, and/or various other OFDMA standards, CDMA standards, TDMA standards and/or FDMA standards, etc.

As illustrated, wireless client devices may include cellular telephones 116 and 118, laptop computers 120 and 122, desktop computers 124 and 126, and data terminals 128 and 130. However, the cellular wireless communication system 100 supports communications with other types of wireless client devices as well. As is generally known, devices such as laptop computers 120 and 122, desktop computers 124 and 126, data terminals 128 and 130, and cellular telephones 116 and 118, are enabled to “surf” the Internet 114, transmit and receive data communications, such as email, transmit and receive files, and perform other data operations. Many of these data operations have significant download data-rate requirements while the upload data-rate requirements are not as severe. Some or all of the wireless client devices 116-130 are therefore enabled to support various 4G standards, such as LTE-A, WirelessMAN-Advanced and IEEE 802.16m. As such, some or all of the wireless client devices 116-130 are configured to employ Multiple-Input Multiple-Output (MIMO) closed loop link adaptation.

The wireless client devices 116-130 supporting MIMO closed loop link adaptation are further configured to generate side information for use in producing channel state information (CSI) that is reported back to the wireless network devices 103-106. In an embodiment, the side information includes scheduling information corresponding to the operation of a scheduler within a wireless network device 103 with respect to MIMO signals sent on the downlink from the wireless network device 103 to a wireless client device 116. For example, the scheduling information may indicate various constraints on the scheduler of the wireless network device 103 related to the generation and transmission of the downlink MIMO signals to the wireless client device 116. Such constraints may include, for example, the particular modulation and coding scheme (MCS) level(s) selected by the wireless network device 103.

In another embodiment, the side information includes channel correlation information indicating the channel correlation on the downlink MIMO channel. As used herein, the term “channel correlation” refers to the degree to which signals on the same MIMO channel appear to be the same to the receiver. Low channel correlation indicates that the signals can be distinguished, allowing for multi-layer transmission (i.e., transmission of multiple different data streams simultaneously and on the same frequency).

In yet another embodiment, the side information includes channel Doppler information indicating the Doppler spread or difference in Doppler shifts between different Radio Frequency (RF) signals of the downlink MIMO channel. The wireless client device 116 uses the side information (i.e., scheduling information, channel correlation information and/or channel Doppler information) to produce an accurate CSI report for use by the wireless network device 103 in scheduling subsequent downlink MIMO transmissions to the wireless client device 116. For example, the wireless network device 103 may allocate one or more transmit antennas, select a particular number of layers (rank), select a particular precoding matrix and/or select a particular MCS level based on the CSI report.

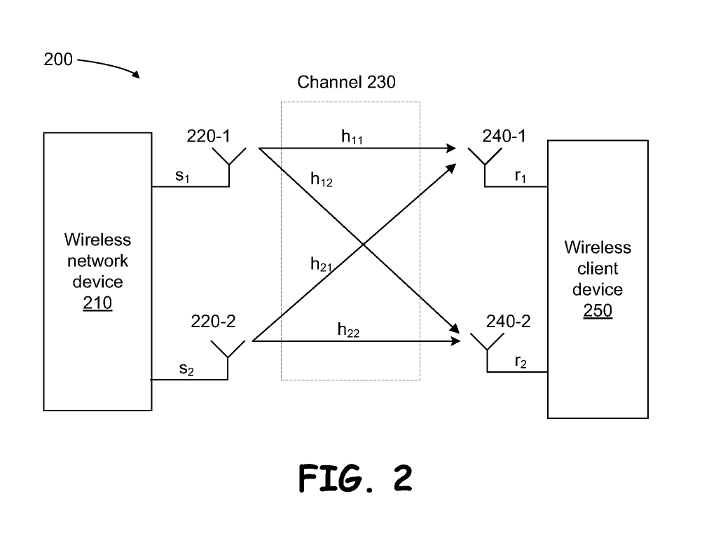

FIG. 2 illustrates an example of a portion of a wireless communication system 200 facilitating a Multiple-Input Multiple-Output (MIMO) transmission between a wireless network device 210 and a wireless client device 250. For simplicity, the wireless network device 210 includes two transmit antennas 220-1 and 220-2 and the wireless client device 250 includes two receive antennas 240-1 and 240-2. However, it should be understood that the number of transmit and/or receive antennas is not limited to two.

Spatial separation between the two antennas at both the wireless network device 210 and the wireless client device 250 create different sub-channels, each including different signal paths and signal path lengths, across a wireless MIMO channel 230. For example, the signal path length of the sub-channel between transmit antenna 220-1 and receive antenna 240-1 is different from the signal path length of the sub-channel between the same transmit antenna 220-1 and receive antenna 240-2. Because of these differences in signal path lengths (and other differences in the sub-channels), a signal transmitted from either one of the transmit antennas 220-1 and 220-2 will arrive at the receive antennas 240-1 and 240-2 with different phase shifts and/or amplitudes. These different phase shifts can be respectively represented by the channel elements h₁₁, h₁₂, h₂₁, and h₂₂ as shown in FIG. 2, or by the channel matrix H given by:

$$H = ( \begin{matrix}{h}_{11} & {h}_{21} \\ {h}_{12} & {h}_{22}\end{matrix} ) \qquad ( 1 )$$

Assuming knowledge about the channel matrix H can be determined and that the channel matrix H is invertible, it is possible to transmit different signals from the transmit antennas 220-1 and 220-2 in parallel and separate the different signals at the wireless client device 250 using spatial multiplexing. For example, the two transmit antennas 220-1 and 220-2 can respectively transmit, in parallel, two different signals s₁ and s₂. The resulting signals r₁ and r₂ respectively received by the receive antennas 240-1 and 240-2 can be expressed as:

$$r = ( \begin{matrix}{r}_{1} \\ {r}_{2}\end{matrix} ) = ( \begin{matrix}{h}_{11} & {h}_{21} \\ {h}_{12} & {h}_{22}\end{matrix} ) \cdot ( \begin{matrix}{s}_{1} \\ {s}_{2}\end{matrix} ) + ( \begin{matrix}{n}_{1} \\ {n}_{2}\end{matrix} ) = H \cdot \overline{s} + \overline{n} \qquad ( 2 )$$

where n̅ is a vector including noise elements n₁ and n₂ that impair the signals received at the different receive antennas 240-1 and 240-2. The transmitted signals s₁ and s₂ can be recovered at the wireless client device 250 with no interference between the signals by multiplying the received vector r̅ by the inverse of the channel matrix H.

In practice, if a linear receiver, such as a ZF receiver, is employed, it is desirable to reduce the interference between the two signals s₁ and s₂ at the wireless client device 250. Therefore, a linear precoder can be used, as discussed above, at the wireless network device 210 to effectively “orthogonalize” the parallel transmissions, thereby reducing interference. Specifically, the channel matrix H (or some estimate of the channel matrix H) can first be expressed as its singular-value decomposition (SVD):

H=U·ΣV* (3)

where U is an N_{RX} by N_{TX} unitary matrix, Σ is an N_{TX} by N_{TX} diagonal matrix, V is an N_{TX} by N_{TX} unitary matrix, and N_{RX} and N_{TX} respectively represent the number of antennas at the receiver and transmitter. After expressing the channel matrix H as its SVD, the matrix V can be applied at the wireless network device 210 by the linear precoder and U* can be applied at the wireless client device 250, leaving an equivalent channel matrix equal to the matrix Σ. Because the matrix Σ is diagonal, the spatially multiplexed signals are effectively “orthogonalized,” which reduces interference at the wireless client device 250.

Also, typically, if higher complex receivers, such as maximum likelihood receivers, are employed, the precoder selection is performed such that the effective receiver SNR or capacity is maximized. In other words, the precoder which maximizes the unconstrained capacity is chosen as the preferred precoding matrix. However, the precoder chosen as above may not be optimum for all the scheduling cases. Thus, in accordance with various embodiments, the wireless client device 250 can determine side information in addition to channel information, as discussed above, to produce a more accurate CSI report for the wireless network device 210.

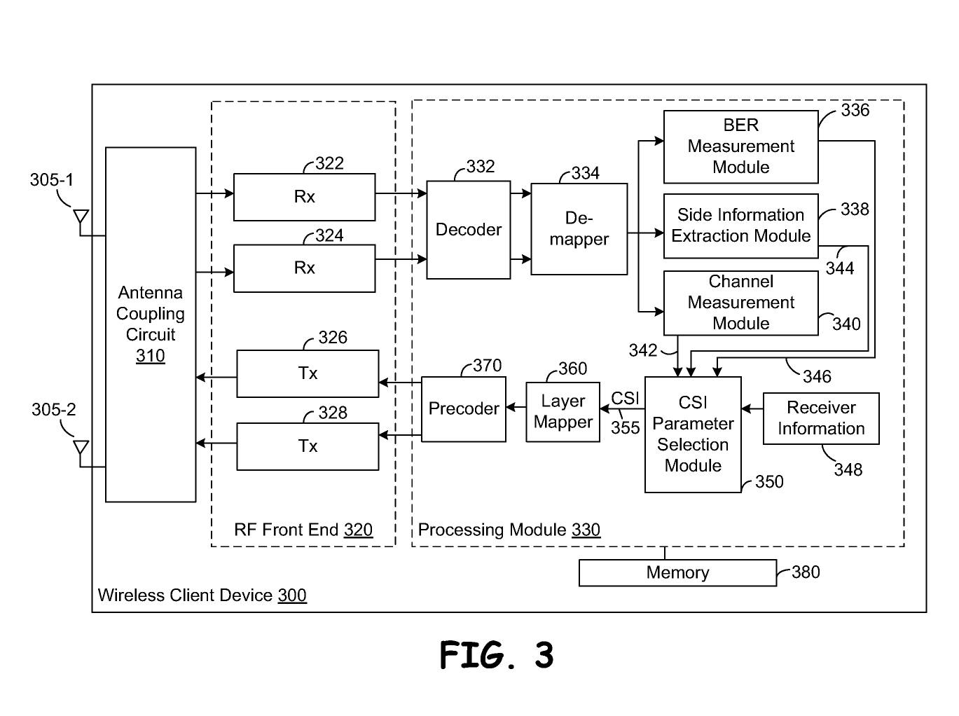

FIG. 3 illustrates an example of an embodiment of a MIMO wireless client device 300 in accordance with the present disclosure. The MIMO wireless client device 300 includes antennas 305-1 and 305-2, an antenna coupling circuit 310, an RF front end 320 and a processing module 330. The antennas 305-1 and 305-2 may be implemented as separate antennas or as an antenna array with cross-polarizations. The RF front end 320 includes receivers 322 and 324 and transmitters 326 and 328. Although only two antennas 305-1 and 305-2 are shown (with a corresponding number of receivers 322 and 324 and transmitters 326 and 328), it should be understood that the number of antennas (and the number of receivers and/or transmitters) is not limited to two. It should also be understood that the number of antennas 305-1 and 305-2 does not necessarily correspond to the number of transmitters 326 and 328 and/or receivers 322 and 324.

In an example MIMO operation, the antennas 305-1 and 305-2 receive an inbound MIMO signal, which includes a plurality of inbound RF signals. Each of the antennas 305-1 and 305-2 may be coupled to a respective one of the receivers 322 and 324 of the RF front end 320 via the coupling circuit 310. The antenna coupling circuit 310 may include, for example, one or more T/R switches, one or more transformer baluns, and/or one or more switching networks. Each receiver 322 and 324 converts a respective one of the inbound RF signals into inbound space-time or space-frequency block encoded symbol streams. For example, each receiver 322 and 324 may operate to amplify, down-convert and filter the respective inbound RF signal to produce a low IF signal or baseband signal that can then be converted from the analog domain to the digital domain to produce the space-time or space-frequency block decoded symbol streams.

The processing module 330, in combination with operational instructions stored in memory 380, demodulates, demaps, descrambles, and/or decodes the space-time or space-frequency block encoded symbol streams to recapture inbound data in accordance with the particular wireless communication standard being implemented by the wireless client device 300. For example, as shown in FIG. 3, the processing module 330 includes a space-time or space-frequency decoder module 332 and a symbol de-mapper module 334 to convert the inbound space-time or space-frequency block encoded symbol streams into the inbound data.

The processing module 330 further includes a Bit Error Rate (BER) measurement module 336, side information extraction module 338 and channel measurement module 340 that each receive and process the inbound data, in accordance with operational instructions stored in memory 380, to determine various channel information 342, 344 and 346. For example, the BER measurement module 336 can measure the BER or Block Error Rate (BLER) from the inbound data, the side information extraction module 338 can determine side information 344, such as scheduling information, channel correlation information and/or channel Doppler information, from the inbound data, and the channel measurement module 340 can determine channel conditions 342, such as the interference and noise power and an estimation of the channel matrix, from the inbound data. The channel information 342, 344 and 346 is provided to a Channel State Information (CSI) parameter selection module 350 that determines parameters for a Channel State Information (CSI) report 355 based on the channel information 342, 344 and 346 and other receiver information 348 (i.e., receiver settings, etc.).

The processing module 330, in combination with operational instructions stored in memory 380, further processes the CSI report 355 in accordance with a particular wireless communication standard (e.g., UMTS/WCDMA, GSM, GPRS, EDGE, et cetera) to encode, scramble, map and/or modulate the CSI report to produce outbound space-time or space-frequency block encoded symbol streams. For example, as shown in FIG. 3, the processing module 330 includes a layer mapper 360 and precoder 370 to convert the CSI report 355 into the outbound space-time or space-frequency block encoded symbol streams. The outbound space-time or space-frequency block encoded symbol streams are digital base-band signals or digital low IF signals, where the low IF is in the frequency range of zero to a few kilohertz/megahertz. It should be understood that the transmit and receive functions provided by the processing module 330 may be implemented using shared processing devices and/or individual processing devices.

The outbound space-time or space-frequency block encoded symbol streams can then be provided to one or more of the transmitters 326 and 328 to convert the space-time or space-frequency outbound block encoded symbol streams into one or more outbound RF signals, depending on whether MIMO is enabled on the uplink. For example, each transmitter 326 and 328 may operate to receive an analog signal corresponding to one of the outbound space-time or space-frequency encoded symbol streams and then up-convert, amplify and filter the respective analog signal to produce an outbound RF signal. The antenna coupling circuit 310 then provides the outbound RF signal(s) to one or more of the antennas 305-1 and 305-2 for transmission to the wireless network device.

The parameters within the CSI report 355 include, for example, a precoding matrix index (PMI), channel quality indicator (CQI) and a rank indicator (RI). In addition, the observed signal-to-noise (SNR) or signal-to-interference-plus-noise (SINR) 346 may also be included in the CSI report 355.

The precoding matrix index (PMI) is used to index into a codebook of precoding matrices (precoders) maintained at the wireless network device and wireless client device. By appropriately choosing the precoder based on the channel information 342, 344 and 346, multiple different data streams (layers) can be simultaneously emitted from the transmit antennas of the wireless network device with independent and appropriate weightings such that the link throughput is maximized at the wireless client device 300. For example, each precoding matrix P may be an M×N matrix, where M represents the number of transmit antennas and N represents the number of layers. As such, the Pᵢⱼ element of the precoding matrix indicates the weighting to be applied to a particular transmit stream (layer) over a particular transmit antenna. The PMI is determined, for example, from the SVD of the channel matrix H and the capacity of the MIMO channel. The channel capacity may be approximated by the observed SNR/SINR 346.

The rank indicator (RI) informs the wireless network device of the number of layers (data streams) that can be transmitted over the MIMO channel. The rank may also be determined, for example, from the capacity of the MIMO channel. The channel quality indicator (CQI) is used by the wireless network device to determine a suitable downlink transmission data rate, i.e., a Modulation and Coding Scheme (MCS) level. The CQI may be, for example, a 4-bit integer, and is based on the observed SINR (channel capacity), but also takes into account receiver information 348, such as the number of antennas and the type of receiver.

In accordance with various embodiments, the channel capacity may be determined based on the side information 344. For example, in embodiments in which the side information 344 includes scheduling information, the CSI parameter selection module 350 can use the scheduling information to measure the “scheduler constrained capacity” of a channel, defined herein as the maximum information that can be received on a MIMO channel with constraints on the scheduler in the wireless network device. The CSI parameter selection module 350 can then use the scheduler constrained capacity to determine one or more of the PMI, RI and CQI. The “scheduler constrained capacity” can be differentiated from the “unconstrained capacity,” which is defined herein as the Shannon capacity or the channel capacity without scheduler constraints.

Examples of scheduling information that may contribute to the scheduler constrained capacity include, but are not limited to, an indication that the wireless network device is using a fixed MCS level on one or more layers and an indication that the wireless network device is using a different MCS level on one or more layers other than the MCS level suggested by the CQI in previous channel state. For example, the scheduling information may indicate that the wireless network device is using a more conservative MCS level or more aggressive MCS level than the suggested MCS level. Other examples of scheduling information that may contribute to the scheduler constrained capacity include, but are not limited to, an indication that the wireless network device is using a different rank than that suggested in a previous CSI report and an indication that the wireless network device is using a different precoder than suggested in a previous CSI report.

The scheduler constrained capacity can be used by the CSI parameter selection module 350 to select the PMI. For example, the CSI parameter selection module 350 may choose the PMI that maximizes the scheduler constrained capacity, and transmit the selected PMI as part of the CSI report 355 to the wireless network device. The wireless network device can then use the precoding matrix indicated by the selected PMI to transmit subsequent downlink MIMO signals to the wireless client device. By selecting the PMI based on the scheduling information/scheduler constrained capacity, the throughput can be maximized regardless of, and with respect to, the particular MCS level actually used.

The scheduler constrained capacity can also be used by the CSI parameter selection module 350 in selecting the rank indicator (RI) and channel quality indicator (CQI). For example, in embodiments in which the wireless network device is using a fixed MCS, the CSI parameter selection module 350 may select the RI that maximizes the scheduler constrained capacity. As another example, in embodiments in which the wireless network device selects a MCS level that is conservative or aggressive with respect to a previously reported CQI and/or the wireless network device selects a different precoder than that suggested in a previous CSI report, the CSI parameter selection module 350 may select the CQI based on the scheduler constrained capacity to maximize the throughput on the MIMO channel.

In embodiments in which the side information includes channel correlation information, the CSI parameter selection module 350 can select a particular PMI that maximizes the throughput based on the channel correlation. For example, when the magnitude of the channel correlation is high (at low to moderate SNR), the CSI parameter selection module 350 may select the PMI corresponding to the precoder that maximizes the capacity imbalance between the layers. The total unconstrained capacity (or scheduler constrained capacity when scheduling information is also used) over the layers is the sum of the capacities on individual layers. Therefore, for example, in a two layer system, the precoder that maximizes the capacity imbalance streams most of the capacity into one of the two layers.

In embodiments in which the side information includes channel Doppler information, the CSI parameter selection module 350 can select a particular PMI that maximizes the throughput based on the channel Doppler and channel correlation (if channel correlation information is also used).

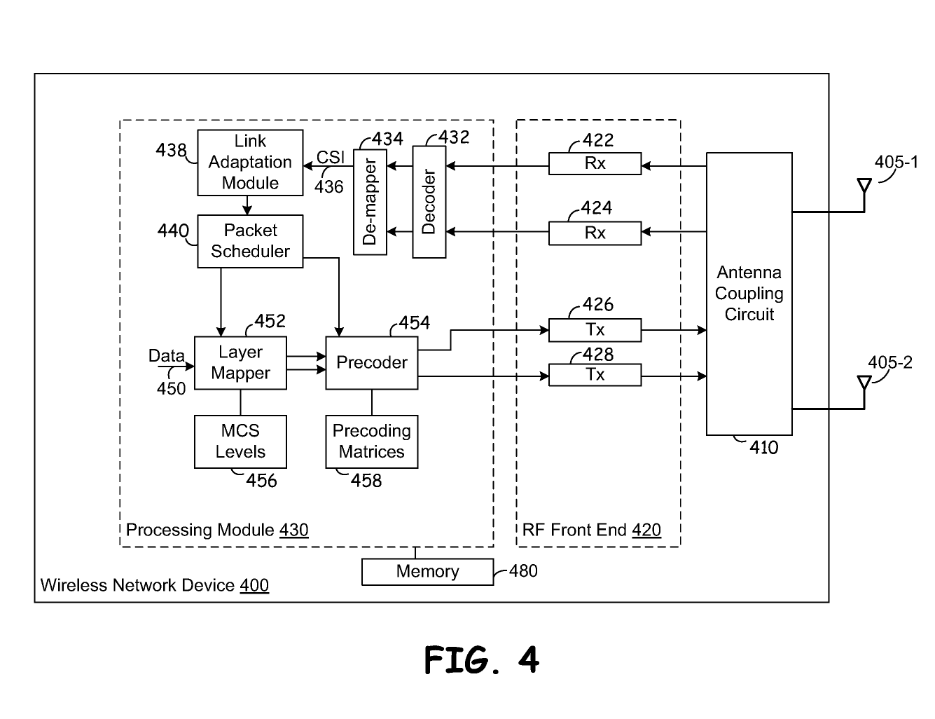

FIG. 4 illustrates an example of an embodiment of a MIMO wireless network device 400 in accordance with the present disclosure. The MIMO wireless network device 400 includes antennas 405-1 and 405-2, an antenna coupling circuit 410, an RF front end 420 and a processing module 430. The RF front end 420 includes receivers 422 and 424 and transmitters 426 and 428. Although only two antennas 405-1 and 405-2 are shown (with a corresponding number of receivers 422 and 424 and transmitters 426 and 428), it should be understood that the number of antennas (and likewise, the number of receivers and/or transmitters) is not limited to two. It should also be understood that the number of antennas 405-1 and 405-2 does not necessarily correspond to the number of transmitters 426 and 428 and/or receivers 422 and 424.

In an example operation, one or more of the antennas 405-1 and 405-2 receives an inbound RF signal from a wireless client device. The inbound RF signal may include one or more inbound RF signals, depending on whether MIMO is enabled on the uplink. In addition, one or more of the antennas 405-1 and 405-2 may be coupled to one or more respective receivers 422 and 424 of the RF front end 420 via the coupling circuit 410 depending on the receive antenna configuration. The receiver(s) 422 and 424 convert the inbound RF signal into inbound symbol streams. For example, each receiver 422 and 424 may operate to amplify, down-convert and filter the respective inbound RF signal to produce a low IF signal or baseband signal that can then be converted from the analog domain to the digital domain to produce the inbound symbol streams

The processing module 430, in combination with operational instructions stored in memory 480, demodulates, demaps, descrambles, and/or decodes the inbound symbol streams to recapture inbound data in accordance with the particular wireless communication standard being implemented by the wireless network device 400. For example, as shown in FIG. 4, the processing module 430 includes a decoder module 432 and a symbol de-mapper module 434 to convert the inbound symbol streams into inbound data.

The processing module further includes a link adaptation module 438 configured to receive the inbound data. When the inbound data includes a CSI report 436 generated in accordance with the embodiments described above with respect to FIG. 3, the link adaptation module 438 extracts the PMI, RI and CQI from the CSI report 436 and selects the rank, MCS level and precoder for use in subsequent transmissions to the wireless client device based at least in part on the PMI, RI and CQI. Other information that may be considered by the link adaptation module 438 includes, but is not limited to, the BER target requirements, latency requirements, quality of service parameters, buffered payloads, capabilities of the wireless client device and other system parameters.

In addition, the link adaptation module 438 may further consider scheduler constraints on a packet scheduler 440 when determining the rank, MCS level and precoder. Such constraints include, for example, that the packet scheduler 440 may only use a fixed MCS level for one or more layers or may use a more aggressive/conservative MCS level than that suggested by the CQI.

The link adaptation module 438 further communicates with the packet scheduler 440 to provide the selected rank, MCS level and precoder for use by the packet scheduler 440 in allocating time/frequency resources for downlink transmissions to the wireless client device. For example, the packet scheduler 440 can control a layer mapper 452 and precoder 454 to convert outbound data 450 into outbound space-time or space-frequency block encoded symbol streams. In an embodiment, the layer mapper 452 can convert the outbound data 450 into two or more parallel data streams (layers) and then modulate each data stream using a MCS level (e.g., QPSK, 16QAM, 64QAM and corresponding FEC rates, etc.) selected from available MCS levels 456, as indicated by the packet scheduler 440, to produce two or more modulated symbol streams.

The precoder 454 can then apply a precoding matrix selected from a codebook of precoding matrices 458, as indicated by the packet scheduler 440, to the modulated symbol streams to provide appropriate weightings to each of the modulated symbol streams to produce the space-time or space-frequency block encoded symbol streams for transmission over one or more of the transmit antennas 405-1 and 405-2. For example, when the SINR is similar on the streams transmitted from each of the transmit antennas 405-1 and 405-2, the PMI may indicate that the precoder 454 should apply the precoding matrix that provides each layer to a separate transmit antenna 405-1 and 405-2. As another example, when the SINR is different on the transmit streams, the PMI may indicate that the precoder 454 should apply a precoding matrix that divides each layer between the transmit antennas 405-1 and 405-2 with respective weightings in an effort to equalize the SINR between the layers. Thus, in this example, each transmit antenna 405-1 and 405-2 would transmit data streams that include at least a portion of two or more layers.

The outbound space-time or space-frequency block encoded symbol streams are then provided to respective transmitters 426 and 428 of the RF front end 420 to convert the outbound space-time or space-frequency block encoded symbol streams into a plurality of outbound RF signals. For example, each transmitter 426 and 428 may operate to receive an analog signal corresponding to one of the outbound space-time or space-frequency encoded symbol streams and then up-convert, amplify and filter the respective analog signal to produce an outbound RF signal. The antenna coupling circuit 410, which may include one or more T/R switches, one or more transformer baluns, and/or one or more switching networks, provides the plurality of outbound RF signals to the antennas 405-1 and 405-2 for transmission of the plurality of outbound RF signals to the wireless client device as an outbound MIMO RF signal.

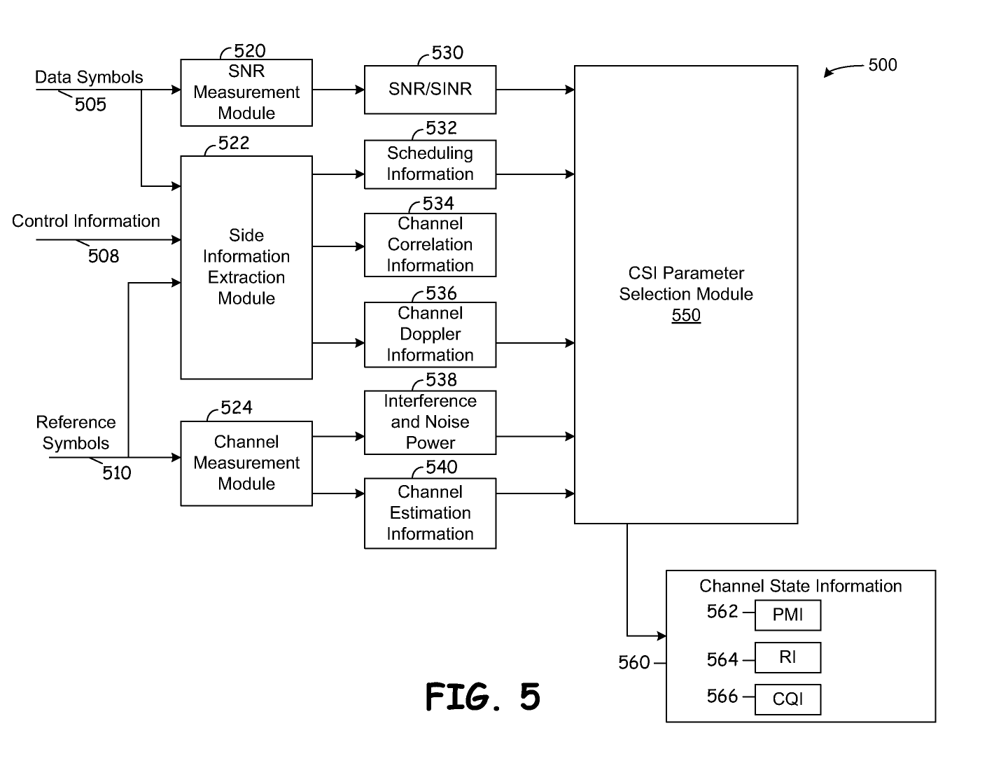

FIG. 5 illustrates an example of an operation of a processing module 500 within a MIMO wireless client device in accordance with the present disclosure. The processing module 500 includes a SNR measurement module 520, side information extraction module 522, channel measurement module 524 and Channel State Information (CSI) parameter extraction module 550. The SNR measurement module 520, side information extraction module 522, channel measurement module 524 and CSI parameter selection module 550 may each operate using one or more algorithms (sets of instructions) executable by the processing module 500. The instructions may be hard coded into the processing module 500 and/or stored within a memory device accessible to the processing module 500.

The inbound data received from a wireless network device includes both data symbols 505 and reference symbols 510. Reference symbols 510 are typically inserted into each RF signal transmitted from each transmit antenna at the wireless network device to enable the wireless client device to estimate the channel quality of each downlink path. Thus, the reference symbols 510 are extracted from the inbound data and provided to the channel measurement module 524 to measure various channel conditions, such as the interference and noise power 538 and channel estimation information 540 corresponding to the estimated channel matrix H.

In addition, the reference symbols 510, along with the data symbols 505 and downlink control information 508, are also provided to the side information extraction module 522 to enable the side information extraction module 522 to determine scheduling information 532, channel correlation information 534 and channel Doppler information 536. The SNR measurement module 520 also uses the data symbols 505 to measure the SNR/SINR 530 of the MIMO channel.

The CSI parameter selection module 550 uses the SNR/SINR 530, scheduling information 532, channel correlation information 534, channel Doppler information 536, interference and noise power 538 and channel estimation information 540 to determine the parameters for the Channel State Information (CSI) report 560. For example, the CSI report 560 can include the precoding matrix index (PMI) 562, rank indicator (RI) 564 and channel quality indicator (CQI) 566, as discussed above.

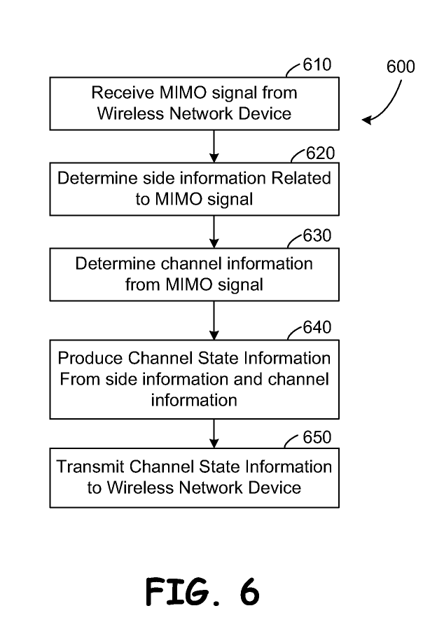

FIG. 6 illustrates an example of a method 600 for determining channel state information within a MIMO wireless client device in accordance with the present disclosure. The method begins at 610, where the wireless client device receives a MIMO signal from a wireless network device over a MIMO channel. At 620, the wireless client device determines side information related to the MIMO signal. For example, the side information may include one or more of scheduling information, channel correlation information and channel Doppler information. In addition, at 630, the wireless client device further determines other channel information from the MIMO signal. For example, the other channel information may include one or more of the SNR/SINR, noise and interference power and an estimate of the channel matrix.

The method continues at 640, where the wireless client device produces a Channel State Information (CSI) report from the side information and the other channel information. The CSI report may include, for example, a precoding matrix index (PMI), rank indicator (RI) and a channel quality indicator (CQI). At 650, the wireless client device transmits the CSI report to the wireless network device for use by the wireless network device in transmitting subsequent MIMO signals to the wireless client device.

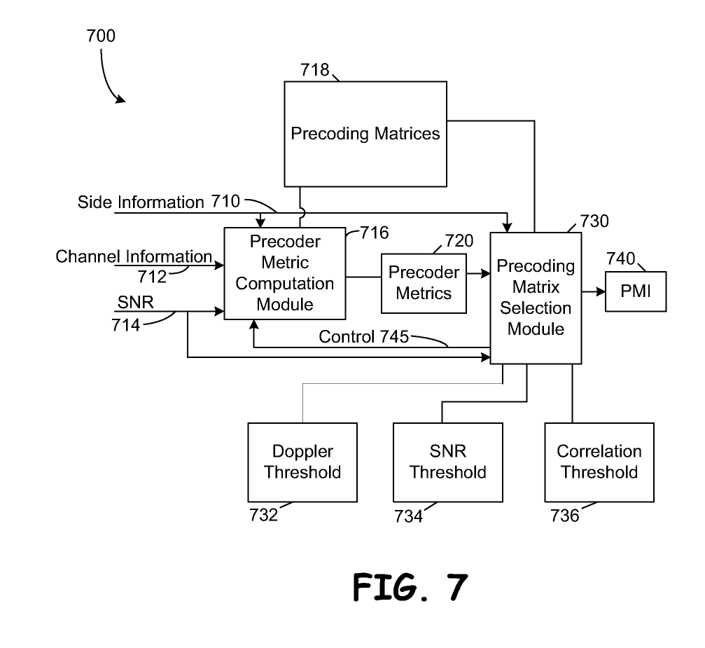

FIG. 7 illustrates an example of an operation of a Channel State Information (CSI) parameter selection module 700 within a MIMO wireless client device for determining a precoding matrix index (PMI) 740 in accordance with the present disclosure. The CSI parameter selection module 700 includes a precoder metric computation module 716 and precoding matrix selection module 730. The precoder metric computation module 716 and precoding matrix selection module 730 may each operate using one or more algorithms (sets of instructions) executable by the wireless client device processing module. The instructions may be hard coded into the processing module and/or stored within a memory device accessible to the processing module.

The precoder metric computation module 716 takes as input side information 710, channel information 712 and a Signal-to-Noise Ratio (SNR) or Signal-to-Interference-Plus-Noise Ratio (SINR) 714 and determines a precoder metric 720 for each precoder matrix 718. The side information 710 includes scheduling information indicating, for example, the MCS level and/or precoding matrix selected by the wireless network device for transmitting MIMO signals to the wireless client device. The channel information 712 may include, for example, channel estimation information. The SNR/SINR 714 may include a single SNR/SINR for the MIMO channel and/or may include separate SNR/SINR's for each sub-channel (path) of the MIMO channel. The SNR/SINR 714 may be measured, for example, based on the total receive power of the MIMO signal and the measured interference and noise power.

In an exemplary embodiment, the precoder metrics 720 represent the scheduler constrained capacity associated with each of the precoder matrices 718. For example, the precoder metric computation module 716 can use the scheduling information 710, along with the channel information 712 and/or the SNR/SINR 714 to determine the scheduler constrained metric (which optimizes the scheduler constrained capacity) for the precoder matrix currently being used by the wireless network device and then extrapolate the scheduler constrained capacities for other precoder matrices based on the calculated scheduler constrained capacity for the current precoder matrix, the scheduling information 710 and the channel information 712.

In another embodiment, the precoder metrics 720 represent effective SNR or unconstrained capacity values extrapolated from the measured SNR/SINR of the current precoding matrix 718 and based on the scheduling information. In this embodiment, the SNR/SINR is used as an approximation for the scheduler constrained capacity. In yet another embodiment, the precoder metrics 720 represent the capacity imbalance between the layers (i.e., in a two-layer system, the capacity imbalance refers to the difference between the amount or percentage of total capacity streamed into each layer). In this embodiment, the capacity imbalance may be based on the unconstrained capacity or the scheduler constrained capacity.

In an embodiment, the precoder metric computation module 716 determines a single precoder metric 720 for each of the precoding matrices 718 based on a control signal 745 generated by the precoding matrix selection module 730. For example, the control signal 745 may instruct the precoder metric computation module 716 to compute the unconstrained capacity for each precoding matrix or the scheduler constrained capacity for each precoder matrix. In another embodiment, the precoder metric computation module 716 determines multiple precoder metrics 720 (i.e., unconstrained capacity metrics and scheduler constrained capacity metrics) for each of the precoding matrices 718. In this embodiment, the precoder metric computation module 716 may be pre-programmed to determine the multiple precoder metrics 720 without the control signal 745 or may be instructed to determine the multiple precoder metrics 720 via the control signal 745.

The precoding matrix selection module 730 analyzes the precoder metrics 720, and based on one or more criteria, outputs the PMI 740 corresponding to the precoding matrix 718 that optimizes the metric. The criteria may be determined, for example, from the side information 710 and the SNR/SINR 714.

As an example, in embodiments in which the side information 710 indicates that the wireless network device is using an adaptive MCS level that corresponds with the CQI, the precoding matrix selection module 730 may select the PMI 740 corresponding to the precoding matrix 718 having the precoder metric 720 with the maximum effective SNR or “unconstrained” capacity. In this example, the precoding matrix selection module 730 may instruct the precoder metric computation module 716 via the control signal 745 to determine the unconstrained capacity or effective SNR for each precoding matrix 718 as the precoder metrics 720.

As another example, in embodiments in which the side information 710 indicates that the wireless network device is using a fixed MCS level or an MCS level that is more aggressive or conservative than the CQI, the precoding matrix selection module 730 may instruct the precoder metric computation module 716 to compute precoder metrics 720 that indicate the scheduler constrained metric for, e.g., capacity imbalance between the layers. In addition, the precoding matrix selection module 730 may further select the PMI 740 based on the SNR/SINN 714. For example, the precoding matrix selection module 730 can compare the SNR/SINR 714 to an SNR threshold 734 and select the PMI 740 based on the results of the comparison. The SNR threshold 734 can be predetermined or dynamically set based on the side information 710 and/or other information, as may be appropriate.

In an example operation, when the precoding matrix selection module 730 determines that the SNR/SINR 714 exceeds (or equal to in some embodiments) the SNR threshold 734, the precoding matrix selection module 730 selects the PMI corresponding to the precoding matrix 718 having the precoder metric 720 with the minimum capacity imbalance between the layers. As such, when the SNR/SINR 714 is high, the capacity can be shared between layers, thus maximizing the throughput achievable using spatial multiplexing.

In another example operation, when the precoding matrix selection module 730 determines that the SNR/SINR 714 is less than (or is equal to in some embodiments) the SNR threshold 734, the precoding matrix selection module 730 selects the PMI 740 corresponding to the precoding matrix 718 having the precoder metric 720 with the maximum capacity imbalance between the layers. As such, when the SNR/SINR 714 is low, most of the capacity can be streamed into one of the layers to attempt to boost the SNR/SINR.

In embodiments in which the side information 710 includes channel correlation information, the precoding matrix selection module 730 may select the PMI 740 based on the channel correlation and the SNR/SINR 714. For example, the precoding matrix selection module 730 can compare the channel correlation to a channel correlation threshold 736 and the SNR/SINR 714 to an SNR threshold 734 to select the PMI 740. The channel correlation threshold 736 and SNR threshold 734 can be predetermined or dynamically set based on the side information 710 and/or other information, as may be appropriate.

In an example operation, when the precoding matrix selection module 730 determines that the magnitude of the channel correlation is less than (or equal to in some embodiments) the channel correlation threshold 736, the precoding matrix selection module 730 can select the PMI 740 corresponding to the precoding matrix 718 having the precoder metric 720 with the maximum unconstrained capacity. Thus, in this example, the precoding matrix selection module 730 may instruct the precoder metric computation module 716 via the control signal 745 to compute the unconstrained capacities for each of the precoding matrices 718 as the precoder metrics 720.

In another example operation, when the precoding matrix selection module 730 determines that the channel correlation exceeds (or is equal to in some embodiments) the channel correlation threshold 736, the precoding matrix selection module 730 compares the SNR/SINR 714 to the SNR threshold 734, and selects the PMI 740 as discussed above. For example, when the SNR/SINR 714 is low, the precoding matrix selection module 730 may select the PMI 740 with the precoder metric 720 that maximizes the capacity imbalance between the layers. When the SNR/SINR 714 is high, the precoding matrix selection module 730 may select the PMI 740 with the precoder metric 720 that minimizes the capacity imbalance between the layers. Thus, in this example, the precoding matrix selection module 730 may instruct the precoder metric computation module 716 via the control signal 745 to compute the capacity imbalance between the layers for each of the precoding matrices 718 as the precoder metrics 720.

In embodiments in which the side information 710 includes channel Doppler information, the precoding matrix selection module 730 may select the PMI 740 based on the channel Doppler and the SNR/SINR 714. For example, the precoding matrix selection module 730 can compare the channel Doppler to a channel Doppler threshold 732 and the SNR/SINR 714 to an SNR threshold 734 to select the PMI 740.

In addition, if the channel correlation is also included in the side information, the precoding matrix selection module 730 may further select the PMI 740 based on the channel correlation. For example, the precoding matrix selection module 730 can further compare the channel correlation to a channel correlation threshold 736 to select the PMI 740. The channel correlation threshold 736, channel Doppler threshold 732 and SNR threshold 734 can be predetermined or dynamically set based on the side information 710 and/or other information, as may be appropriate.

In an example operation, when the precoding matrix selection module 730 determines that the channel Doppler exceeds (or is equal to in some embodiments), the channel Doppler threshold 732, the precoding matrix selection module 730 may set the SNR threshold 734 to a first threshold amount. In addition, when the channel Doppler is less than (or equal to in some embodiments) the channel Doppler threshold 732, the precoding matrix selection module 730 may set the SNR threshold 734 to a second threshold amount. In an exemplary embodiment, the first SNR threshold amount is greater than the second SNR threshold amount. Thus, when the magnitude of the channel Doppler is high (large Doppler spread, which indicates significant channel fading), having a higher SNR threshold can result in an improved signal quality.

In this example, the precoding matrix selection module 730 then compares the SNR/SINR 714 to the SNR threshold 734 (set based on the channel Doppler), and selects the PMI 740 as discussed above. For example, when the SNR/SINR 714 is low, the precoding matrix selection module 730 may select the PMI 740 with the precoder metric 720 that maximizes the capacity imbalance between the layers. When the SNR/SINR 714 is high, the precoding matrix selection module 730 may select the PMI 740 with the precoder metric 720 that minimizes the capacity imbalance between the layers. Thus, in this example, the precoding matrix selection module 730 may instruct the precoder metric computation module 716 via the control signal 745 to compute the capacity imbalance between the layers for each of the precoding matrices 718 as the precoder metrics 720.

In another example operation, when the channel correlation information is also included in the side information 710, the precoding matrix selection module 730 may further compare the channel correlation to the channel correlation threshold 736, as discussed above. For example, if the magnitude of the channel correlation is less than (or equal to in some embodiments) the channel correlation threshold 736, the precoding matrix selection module 730 can select the PMI 740 corresponding to the precoding matrix 718 having the precoder metric 720 with the maximum unconstrained capacity.

However, when the precoding matrix selection module 730 determines that the channel correlation exceeds (or is equal to in some embodiments) the channel correlation threshold 736, the precoding matrix selection module 730 can compare the SNR/SINR 714 to the SNR threshold 734 (set based on the channel Doppler), and select the PMI 740 as discussed above. For example, when the SNR/SINR 714 is low, the precoding matrix selection module 730 may select the PMI 740 with the precoder metric 720 that maximizes the capacity imbalance between the layers. When the SNR/SINR 714 is high, the precoding matrix selection module 730 may select the PMI 740 with the precoder metric 720 that minimizes the capacity imbalance between the layers. Thus, in this example, the precoding matrix selection module 730 may instruct the precoder metric computation module 716 via the control signal 745 to compute both the capacity imbalance between the layers and the unconstrained capacities for each of the precoding matrices 718 as the precoder metrics 720.

In the above embodiments in which the precoding matrix selection module 730 uses the channel correlation information to select the PMI 740, the selection is based on the magnitude of the channel correlation. In other embodiments, the phase of the channel correlation may also be used by the precoding matrix selection module 730 to select the PMI 740.

The phase of channel correlation signifies the delay difference between the signals received from the transmit antennas of the wireless network device, and therefore, the phase of channel correlation may indicate that a particular precoding matrix should be used. For example, in embodiments in which the codebook includes two precoding matrices 718 (Precoder 0 and Precoder 1) and two layers are possible, as the phase of the transmit correlation changes from 0 to 360°, the optimal PMI 740 changes periodically between the two precoders depending on different SNR regimes.

For example, Precoder 0 can be defined as:

$${P}_{0} = [ \begin{matrix}1 & 1 \\ 1 & - 1\end{matrix} ] \qquad ( 4 )$$

Likewise, Precodex 1 can be defined as:

$${P}_{1} = \vert \begin{matrix}1 & 1 \\ j & - j\end{matrix} \vert \qquad ( 5 )$$

If the transmit channel correlation is ρe^{jθ}, then covariance matrices of the two layers for Precoder 0 and Precoder 1 are respectively:

$$( \begin{matrix}2 ( 1 + ρ cos θ ) & - 2 jρsinθ \\ 2 jρsinθ & 2 ( 1 - ρcosθ )\end{matrix} ) , ( \begin{matrix}2 ( 1 - ρsinθ ) & - 2 jρcosθ \\ 2 jρcosθ & 2 ( 1 + ρsinθ )\end{matrix} ) \qquad ( 6 )$$

Thus, the level of capacity imbalance over the two layers is also a function of the phase of channel correlation. As such, the precoding matrix selection module 730 can select the PMI 740 with the precoder metric 720 that maximizes or minimizes the capacity imbalance based on the SNR 714 and the phase of channel correlation. For example, when the SNR 714 exceeds (or is equal to in some embodiments) the SNR threshold 734, the precoding matrix selection module 730 can select the PMI 740 that minimizes the capacity imbalance based on the channel correlation phase. In addition, when the SNR 714 is less than (or is equal to in some embodiments) the SNR threshold 734, the precoding matrix selection module 730 can the select the PMI 740 that maximizes the capacity imbalance based on the channel correlation phase. Thus, in this embodiment, the precoder metric computation module 716 may determine the capacity imbalances as a function of the channel correlation phase for each precoding matrix 718 as the precoder metrics 720.

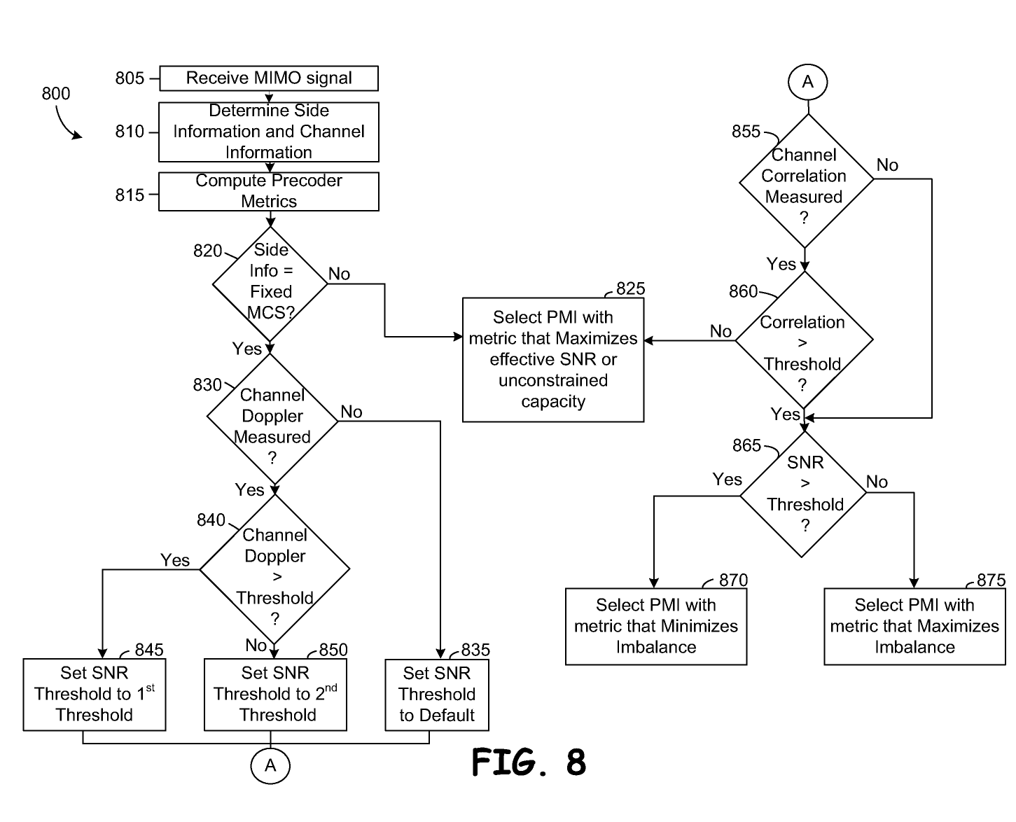

FIG. 8 illustrates an example of a method 800 for determining a precoding matrix index within a MIMO wireless client device in accordance with the present disclosure. The method begins at 805, where a wireless client device receives a MIMO signal from a wireless network device. At 810, the wireless client device determines side information and other channel information from the MIMO signal. For example, the side information can include one or more of scheduling information, channel correlation information and channel Doppler information, and the other channel information can include one or more of an estimated channel matrix and the measured noise and interference power (from which the SNR can be determined based on the measured receive power of the MIMO signal).

At 815, the wireless client device computes one or more precoder metrics for each precoding matrix in the codebook based on the MIMO signal. For example, one or more of the unconstrained capacity, scheduler constrained capacity, SNR and/or capacity imbalance can be computed for each of the precoding matrices.

The method continues at 820, where the wireless client device determines whether the scheduling information indicates that the wireless network device is using a fixed modulation and coding scheme (MCS) level. If the wireless network device is not using a fixed MCS level (and is therefore using an adaptive MCS level), at 825, the wireless client device selects a precoding matrix index (PMI) associated with the precoding matrix having a precoder metric with the maximum effective SNR or unconstrained capacity. If the wireless network device is using a fixed MCS level, at 830, the wireless client device determines whether the side information further included channel Doppler information.

If the side information does not include a channel Doppler measurement, at 835, the wireless client device sets an SNR threshold to a default threshold value. If the side information does include a channel Doppler measurement, at 840, the wireless client device determines whether the channel Doppler exceeds a channel Doppler threshold. If the channel Doppler does exceed the channel Doppler threshold, at 845, the wireless client device sets the SNR threshold to a first threshold value.

If the channel Doppler does not exceed the channel Doppler threshold, at 850, the wireless client device sets the SNR threshold to a second threshold value. In an exemplary embodiment, the default threshold value, first threshold value and second threshold value differ from one another and may be predetermined or set based on other side information, channel information and/or other information.

The method continues at 855, where the wireless client device determines whether the side information includes channel correlation information corresponding to a magnitude of correlation between the received RF signals forming the MIMO channel. If the side information does include a channel correlation magnitude measurement, at 860, the wireless client device determines whether the channel correlation exceeds a channel correlation threshold. If the channel correlation does not exceed the channel correlation threshold, the wireless client device, at 825, selects the PMI associated with the precoding matrix having a precoder metric with the maximum effective SNR or unconstrained capacity.

If the channel correlation does exceed the channel correlation threshold or if the magnitude of the channel correlation was not measured, at 865, the wireless network device determines whether the measured SNR of the MIMO signal exceeds the SNR threshold (set as indicated by the channel Doppler). If the SNR does exceed the SNR threshold, at 870, the wireless client device selects the PMI corresponding to the precoding matrix having a precoder metric that minimizes the capacity imbalance. If the SNR does not exceed the SNR threshold, at 875, the wireless client device selects the PMI corresponding to the precoding matrix having a precoder metric that maximizes the capacity imbalance.

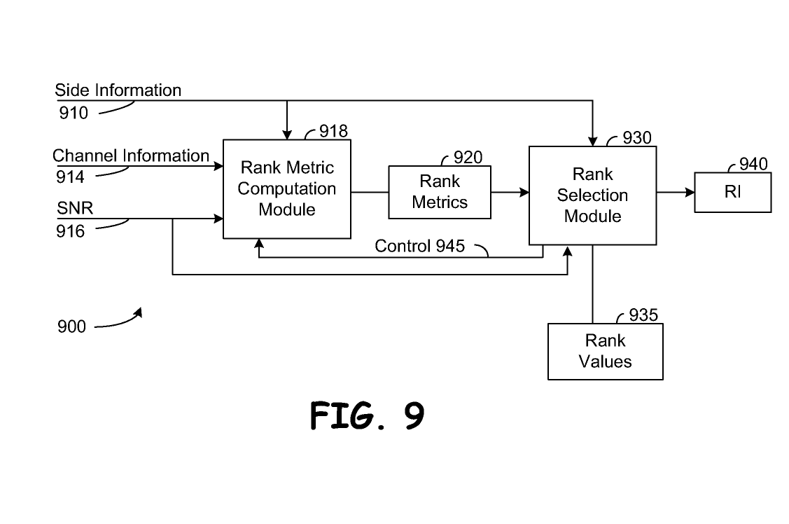

FIG. 9 illustrates an example of an operation of a CSI parameter selection parameter module 900 within a MIMO wireless client device for determining a rank indicator in accordance with the present disclosure. The CSI parameter selection module 900 includes a rank metric computation module 918 and a rank selection module 930. The rank metric computation module 918 and rank selection module 930 may each operate using one or more algorithms (sets of instructions) executable by the wireless client device processing module. The instructions may be hard coded into the processing module and/or stored within a memory device accessible to the processing module.

The rank metric computation module 918 takes as input side information 910, channel information 914 and a Signal-to-Noise Ratio (SNR) or Signal-to-Interference-Plus-Noise Ratio (SINR) 916 and determines a rank metric 920 for each rank 935 (number of layers or data streams) supported by the wireless client device. The side information 910 includes scheduling information indicating, for example, the MCS level and precoding matrix selected by the wireless network device for transmitting MIMO signals to the wireless client device. The channel information 914 may include, for example, channel estimation information. The SNR/SINR 916 may include a single SNR/SINR for the MIMO channel and/or may include separate SNR/SINR's for each sub-channel (path) of the MIMO channel. The SNR/SINR 916 may be measured, for example, based on the total receive power of the MIMO signal and the measured interference and noise power.

In an exemplary embodiment, the rank metrics 920 represent the scheduler constrained capacity associated with each of the ranks 935. For example, the rank metric computation module 918 can use the scheduling information 910, along with the channel information 914 and/or the SNR/SINR 916 to determine the scheduler constrained capacity for the rank currently being used by the wireless network device and then extrapolate the scheduler constrained capacities for other ranks based on the calculated scheduler constrained capacity for the current rank, the scheduling information 910 and the channel information 914. In another embodiment, the rank metrics 920 represent the “unconstrained” capacity associated with each of the ranks 935.

In an embodiment, the rank metric computation module 918 determines a single rank metric 920 for each of the ranks 935 based on a control signal 945 generated by the rank selection module 930. For example, the control signal 945 may instruct the rank metric computation module 918 to compute the unconstrained capacity for each rank or the scheduler constrained capacity for each rank. In another embodiment, the rank metric computation module 918 determines multiple rank metrics 920 (i.e., unconstrained capacity metrics and scheduler constrained capacity metrics) for each of the ranks 935.

The rank selection module 930 analyzes the rank metrics 920, and based on one or more criteria, outputs the rank indicator (RI) 940 corresponding to the rank 935 that optimizes the metric. The criteria may be determined, for example, from the side information 910.

As an example, in embodiments in which the side information 910 indicates that the wireless network device is using an adaptive MCS level that corresponds with the CQI, the rank selection module 930 may select the RI 940 corresponding to the rank 935 having the rank metric 920 with the maximum unconstrained capacity (or effective SNR). As another example, in embodiments in which the side information 910 indicates that the wireless network device is using a fixed MCS level or an MCS level that is more aggressive or conservative than the CQI, the rank selection module 930 selects the RI 940 corresponding to the rank 935 having the rank metric 920 with the maximum scheduler constrained capacity.

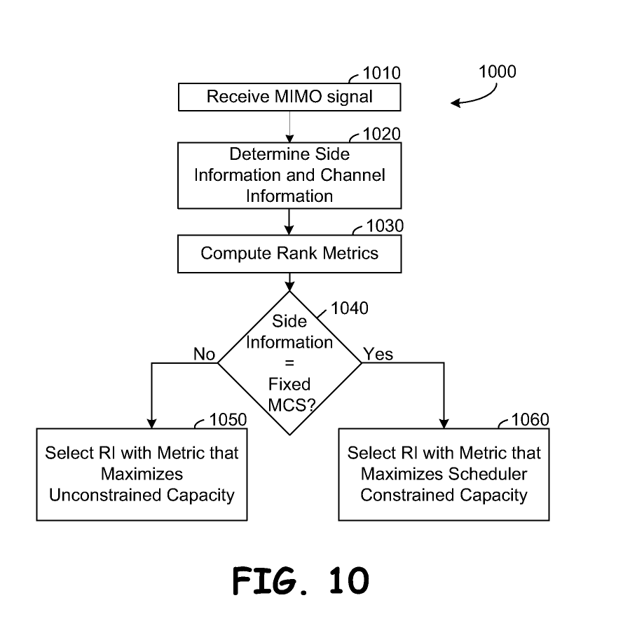

FIG. 10 illustrates an example of a method 1000 for determining a rank indicator within a MIMO wireless client device in accordance with the present disclosure. The method begins at 1010, where the wireless client device receives a MIMO signal from a wireless network device. At 1020, the wireless client device determines side information and other channel information from the MIMO signal. For example, the side information can include scheduling information, and the other channel information can include one or more of an estimated channel matrix and the measured noise and interference power (from which the SNR can be determined based on the measured receive power of the MIMO signal).

At 1030, the wireless client device computes one or more rank metrics for each possible rank (number of layers) based on the MIMO signal. For example, one or more of the unconstrained capacity, scheduler constrained capacity and/or SNR/SINR can be computed for each of the ranks. The method continues at 1040, where the wireless client device determines whether the scheduling information indicates that the wireless network device is using a fixed modulation and coding scheme (MCS) level.

If the wireless network device is not using a fixed MCS level (and is therefore using an adaptive MCS level), at 1050, the wireless client device selects a rank indicator (RI) corresponding to the rank having a rank metric that maximizes the unconstrained capacity or effective SNR. If the wireless network device is using a fixed MCS level, at 1060, the wireless client device selects the RI corresponding to the rank having a rank metric that maximizes the scheduler constrained capacity.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

The term “module” is used in the description of one or more of the embodiments. A module includes a processing module, a functional block, hardware, and/or software stored on memory for performing one or more functions as may be described herein. Note that, if the module is implemented via hardware, the hardware may operate independently and/or in conjunction with software and/or firmware. As also used herein, a module may contain one or more sub-modules, each of which may be one or more modules.

In addition, the terms “processing module” and “processor” may be a single processing device or a plurality of processing devices. Such a processing device may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions. The processing module and/or processor may further have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that if the processing module and/or processor implements one or more of its functions via analog circuitry, digital circuitry, and/or logic circuitry, the memory and/or memory element storing the corresponding operational instructions may be embedded within, or external to, the circuitry comprising the analog circuitry, digital circuitry, and/or logic circuitry. Still further note that, the memory element may store, and the processing module and/or processor executes, hard coded and/or operational instructions corresponding to at least some of the steps and/or functions described herein. Such a memory device or memory element can be included in an article of manufacture.

One or more embodiments of an invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the present disclosure have been expressly described herein, other combinations of these features and functions are likewise possible. The present disclosure is not limited by the particular examples disclosed herein and expressly incorporates these other combinations.

What is claimed is:

1. A wireless client device, comprising:
a radio frequency (RF) front end configured to:
receive an inbound Multiple-Input Multiple-Output (MIMO) signal from a wireless network device over a wireless MIMO channel therebetween, the inbound MIMO signal including two or more RF signals; and
transmit an outbound signal including channel state information to the wireless network device; and
a processing module configured to:
determine side information from the inbound MIMO signal, the side information including scheduling information indicating constraints on the wireless network device related to generation of the inbound MIMO signal; and
produce the channel state information regarding the wireless MIMO channel based on at least the side information and the inbound MIMO signal.

2. The wireless client device of claim 1, wherein the scheduling information comprises:
an indication that determines one or more modulation and coding scheme (MCS) levels that the wireless network device can select from for subsequent MIMO signals.

3. The wireless client device of claim 2, wherein the scheduling information comprises:
another indication as to whether the wireless network device is using a fixed modulation and coding scheme (MCS) or an adaptive MCS, and when the scheduling information indicates that the wireless network device is using an adaptive MCS, the scheduling information further includes an additional indication as to whether the wireless network device is using a corresponding MCS, a conservative MCS or an aggressive MCS with respect to previous channel state information transmitted by the wireless client device to the wireless network device.

4. The wireless client device of claim 1, wherein the channel state information comprises:
a precoding matrix index (PMI) that indicates a suggested precoding matrix to be used by the wireless network device in generating and transmitting subsequent MIMO signals over the wireless MIMO channel.

5. The wireless client device of claim 4, wherein the processing module is further configured to:
determine a precoding metric for each precoding matrix supported by the wireless network device;
determine an optimal metric from the precoding metrics based on at least the side information; and
select the precoding matrix with the optimal metric as the suggested precoding matrix.

6. The wireless client device of claim 5, further comprising:
the precoding metric including an indication regarding an effective signal-to-noise ratio (SNR) or unconstrained capacity of the wireless MIMO channel when using the precoding matrix; and
the processing module further configured to:
select the precoding matrix that maximizes the effective SNR or unconstrained capacity as the suggested precoding matrix when the scheduling information indicates that the wireless network device is using an adaptive modulation and coding scheme (MCS).

7. The wireless client device of claim 5, further comprising:
the scheduling information including an indication that the wireless network device is using a fixed modulation and coding scheme (MCS) level and the precoding metric indicates a capacity imbalance between layers of the inbound MIMO signal; and
the processing module further configured to:
determine a signal-to-noise ratio (SNR) of the wireless MIMO channel based on the inbound MIMO signal;
select the precoding matrix that maximizes the capacity imbalance as the suggested precoding matrix when the SNR is less than a SNR threshold; and
select the precoding matrix that minimizes the capacity imbalance as the suggested precoding matrix when the SNR exceeds the SNR threshold.

8. The wireless client device of claim 7, further comprising:
the side information further including channel correlation information indicating a magnitude of an overall channel correlation of the wireless MIMO channel; and
the processing module further configured to:
select the precoding matrix that maximizes the capacity imbalance as the suggested precoding matrix when the SNR is less than the SNR threshold and the magnitude of the overall channel correlation exceeds a correlation threshold;
select the precoding matrix that minimizes the capacity imbalance as the suggested precoding matrix when the SNR exceeds the SNR threshold and the magnitude of the overall channel correlation exceeds the correlation threshold; and
select the precoding matrix that maximizes an effective SNR or unconstrained capacity as the suggested precoding matrix when the magnitude of the overall channel correlation is less than the correlation threshold.

9. The wireless client device of claim 7, further comprising:
the side information including channel correlation information indicating a phase of an overall channel correlation of the wireless MIMO channel; and
the processing module further configured to:
select the precoding matrix that maximizes the capacity imbalance based on the phase of the overall channel correlation as the suggested precoding matrix when the SNR is less than a SNR threshold; and
select the precoding matrix that minimizes the capacity imbalance based on the phase of the overall channel correlation as the suggested precoding matrix when the SNR exceeds the SNR threshold.

10. The wireless client device of claim 7, further comprising:
the side information including channel Doppler information indicating a Doppler spread between the two or more RF signals of the inbound MIMO signal; and
the processing module further configured to:
set the SNR threshold to a first amount when the Doppler spread exceeds a channel Doppler threshold; and
set the SNR threshold to a second amount when the Doppler spread is less than the channel Doppler threshold;
wherein the first amount is greater than the second amount.

11. The wireless client device of claim 1, further comprising:
the channel state information including a rank indicator (RI) that indicates a suggested rank corresponding to a number of layers to be used by the wireless network device in generating and transmitting subsequent MIMO signals over the wireless MIMO channel; and
the processing module further configured to:
determine a rank metric for each rank supported by the wireless network device and the wireless client device;
determine an optimal metric from the rank metrics based on at least the side information; and
select the rank with the optimal metric as the suggested rank.

12. The wireless client device of claim 11, further comprising:
the rank metric including an indication regarding an unconstrained capacity and a scheduler constrained capacity of the wireless MIMO channel when using the rank; and
the processing module further configured to:
select the rank that maximizes the unconstrained capacity as the suggested rank when the scheduling information indicates that the wireless network device is using an adaptive modulation and coding scheme (MCS); and
select the rank that maximizes the scheduler constrained capacity based on the scheduling information as the suggested rank when the scheduling information indicates that the wireless network device is using a fixed MCS.

13. The wireless client device of claim 1, further comprising:
the channel state information including a channel quality indicator (CQI) that indicates channel conditions of the wireless MIMO channel; and
the processing module further configured to:
determine a scheduler constrained capacity of the wireless MIMO channel, the scheduler constrained capacity indicating a maximum information that can be received on the wireless MIMO channel based on the scheduling information; and
determine the CQI based on the scheduler constrained capacity.

14. A non-transitory memory device having tangibly embodied thereon and accessible therefrom a set of instructions interpretable by at least one processor, the set of instructions comprising:
instructions for determining side information from an inbound Multiple-Input Multiple-Output (MIMO) signal received over a wireless MIMO channel from a wireless network device, the side information including scheduling information indicating constraints related to generation of the inbound MIMO signal by the wireless network device;
instructions for producing channel state information associated with the wireless MIMO channel based on at least the side information and the inbound MIMO signal; and
instructions for providing the channel state information to the wireless network device.

15. The non-transitory memory device of claim 14, wherein the set of instructions further comprises:
instructions for determining a precoding metric for each precoding matrix supported by the wireless network device;
instructions for determining an optimal metric from the precoding metrics based on at least the side information;
instructions for selecting the precoding matrix with the optimal metric as a suggested precoding matrix; and
instructions for including, within the channel state information, a precoding matrix index (PMI) that indicates the suggested precoding matrix to be used by the wireless network device in generating and transmitting subsequent MIMO signals over the wireless MIMO channel.

16. The non-transitory memory device of claim 15, wherein the precoding metric indicates an effective signal-to-noise ratio (SNR) or unconstrained capacity of the wireless MIMO channel when using the precoding matrix, and wherein the set of instructions further comprises:
instructions for selecting the precoding matrix that maximizes the effective SNR or unconstrained capacity as the suggested precoding matrix when the scheduling information indicates that the wireless network device is using an adaptive modulation and coding scheme (MCS).

17. The non-transitory memory device of claim 16, wherein the scheduling information indicates that the wireless network device is using a fixed MCS and the precoding metric further indicates a capacity imbalance between layers of the inbound MIMO signal, and wherein the set of instructions further comprises:
instructions for determining a signal-to-noise ratio (SNR) of the wireless MIMO channel based on the inbound MIMO signal;
instructions for selecting the precoding matrix that maximizes the capacity imbalance as the suggested precoding matrix when the SNR is less than a SNR threshold; and
instructions for selecting the precoding matrix that minimizes the capacity imbalance as the suggested precoding matrix when the SNR exceeds the SNR threshold.

18. The non-transitory memory device of claim 17, wherein the side information further includes channel correlation information indicating a magnitude of an overall channel correlation of the wireless MIMO channel, and wherein the set of instructions further comprises:
instructions for selecting the precoding matrix that maximizes the capacity imbalance as the suggested precoding matrix when the SNR is less than the SNR threshold and the magnitude of the overall channel correlation exceeds a correlation threshold;
instructions for selecting the precoding matrix that minimizes the capacity imbalance as the suggested precoding matrix when the SNR exceeds the SNR threshold and the magnitude of the overall channel correlation exceeds the correlation threshold; and
instructions for selecting the precoding matrix that maximizes an effective SNR or unconstrained capacity as the suggested precoding matrix when the magnitude of the overall channel correlation is less than the correlation threshold.

19. A method for determining channel state information, comprising:
determining side information from an inbound Multiple-Input Multiple-Output (MIMO) signal received over a wireless MIMO channel from a wireless network device, the side information including scheduling information indicating constraints on the wireless network device related to generation of the inbound MIMO signal; and
producing channel state information associated with the wireless MIMO channel for feedback to the wireless network device, the channel state information being produced based on at least the side information and the inbound MIMO signal;
wherein the scheduling information indicates one or more constraints on modulation and coding scheme (MCS) levels that the wireless network device can select from for subsequent MIMO signals.

20. The method of claim 19, further comprising:
determining a precoding metric for each precoding matrix supported by the wireless network device;
determining an optimal metric from the precoding metrics based on at least the side information;
selecting the precoding matrix with the optimal metric as a suggested precoding matrix, the selecting including:
selecting the precoding matrix that maximizes an effective Signal-to-Noise Ratio (SNR) or unconstrained capacity of the wireless MIMO channel as the suggested precoding matrix when the scheduling information indicates that the wireless network device is using an adaptive modulation and coding scheme (MCS);
selecting the precoding matrix that maximizes a capacity imbalance as the suggested precoding matrix when an actual SNR is less than a SNR threshold and the scheduling information indicates that the wireless network device is using a fixed MCS; and
selecting the precoding matrix that minimizes the capacity imbalance as the suggested precoding matrix when the actual SNR exceeds the SNR threshold and the scheduling information indicates that the wireless network device is using a fixed MCS; and
including, within the channel state information, a precoding matrix index (PMI) that indicates the suggested precoding matrix to be used by the wireless network device in generating and transmitting the subsequent MIMO signals over the wireless MIMO channel.
